(19) United States
(12) Patent Application Publication
(10) Pub. No.: US 2025/0245936 A1
(43) Pub. Date: Jul. 31, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TAKANORI KATSUMATA, Kanagawa (JP)

(21) Appl. No.: 19/036,639

(22) Filed: Jan. 24, 2025

(30) Foreign Application Priority Data
Jan. 29, 2024 (JP) 2024-010767

(51) Int. Cl. G06T 19/00; G06V 40/18

(52) U.S. Cl. CPC G06T 19/006; G06V 40/18

(57) ABSTRACT

An information processing apparatus for controlling display of a display apparatus worn by a user includes an acquisition unit configured to acquire a line-of-sight image of another user wearing another display apparatus and information about a virtual object corresponding to a real object disposed in a space where the other user exists, and a generation unit configured to generate a combined image including at least the line-of-sight image of the other user when a line-of-sight of the user to the virtual object displayed on the display apparatus and a line-of-sight of the other user to the real object satisfy a predetermined criterion.

### BACKGROUND

### Field of the Disclosure

The present disclosure relates to an information processing apparatus, an information processing method, and a storage medium.

### Description of the Related Art

A Mixed Reality (MR) technique is known as a technique for blending a virtual world into the real world in real time. This technique seamlessly mixes a virtual space generated by a computer with the real space. MR allows a user to experience a virtual space in a viewpoint as close to the reality as possible by using a head-mounted apparatus or a Head Mount Display (HMD).

A technique is known to allow a user to communicate with a remote user in a space where the user can share the same object with the remote user through the combination of a technique for sharing three-dimensional models (persons and objects) in real time and an Extended Reality (XR) device.

In information gathering for generating a three-dimensional virtual object, usable methods include a method for using multi-viewpoint images acquired by a plurality of cameras and a method for using a Red, Green, Blue, Depth (RGBD) sensor or a depth sensor such as a Time Of Flight (TOF) sensor. To reproduce a target object in real time based on a large amount of three-dimensional information, at present, there is no choice but to permit the degradation of the image quality of the generated three-dimensional model. In this case, in taking communication using the generated three-dimensional model as a subject, the degraded image quality may cause a situation where the information intended by the user is not conveyed.

For example, Japanese Patent Application Laid-Open No. 2019-86578 discusses a technique for changing the moving image to be displayed on an HMD by using a Virtual Reality (VR) moving image display system capable of switching between viewpoints of a plurality of cameras.

However, the technique discussed in Japanese Patent Application Laid-Open No. 2019-86578 changes the screen to be displayed on the display of the HMD, possibly degrading the feeling of immersion of the user. There is a demand for a technique for performing preferable communication in a simultaneous experience shared with a plurality of persons in an MR space.

### SUMMARY

In view of the above-described issue, the present disclosure is directed to providing a technique for generating a real object as a virtual object, and performing preferable communication in a simultaneous experience shared with a plurality of persons in an MR space.

According to an aspect of the present disclosure, an information processing apparatus for controlling display of a display apparatus worn by a user includes an acquisition unit configured to acquire a line-of-sight image of another user wearing another display apparatus and information about a virtual object corresponding to a real object disposed in a space where the other user exists, and a generation unit configured to generate a combined image including at least the line-of-sight image of the other user when a line-of-sight of the user to the virtual object displayed on the display apparatus and a line-of-sight of the other user to the real object satisfy a predetermined criterion.

Further features of the present disclosure will become apparent from the following description of exemplary embodiments with reference to the attached drawings.

### BRIEF DESCRIPTION OF THE DRAWINGS

FIGS. 1A and 1B illustrate positional relations of a first and a second user according to one or more aspects of the present disclosure.

FIG. 2 illustrates a positional relation when a plurality of users shares a Mixed Reality (MR) space according to one or more aspects of the present disclosure.

FIG. 3 is a block diagram illustrating an example functional configuration of a system according to one or more aspects of the present disclosure.

FIG. 4 illustrates an example hardware configuration of an information processing apparatus.

FIG. 5 illustrates a positional relation of the first user according to one or more aspects of the present disclosure.

FIG. 6 illustrates a positional relation of the second user according to one or more aspects of the present disclosure.

FIGS. 7A and 7B illustrates positional relations of the first and the second users according to one or more aspects of the present disclosure.

FIGS. 8A and 8B illustrate line-of-sight images of the first and the second users according to one or more aspects of the present disclosure.

FIG. 9 is a flowchart illustrating line-of-sight image display determination processing according to one or more aspects of the present disclosure.

FIG. 10 is a flowchart illustrating line-of-sight image display position and orientation calculation processing according to one or more aspects of the present disclosure.

FIG. 11 is a flowchart illustrating line-of-sight image display determination processing according to one or more aspects of the present disclosure.

FIG. 12 illustrates a region (common region) where a sphere of a gaze point region of the first user overlaps with a sphere of a gaze point region of the second user, on an xy plane.

FIG. 13 is a flowchart illustrating processing performed before a line-of-sight image of the first user acquired by the information processing apparatus is presented to the second user via the information processing apparatus.

### DESCRIPTION OF THE EMBODIMENTS

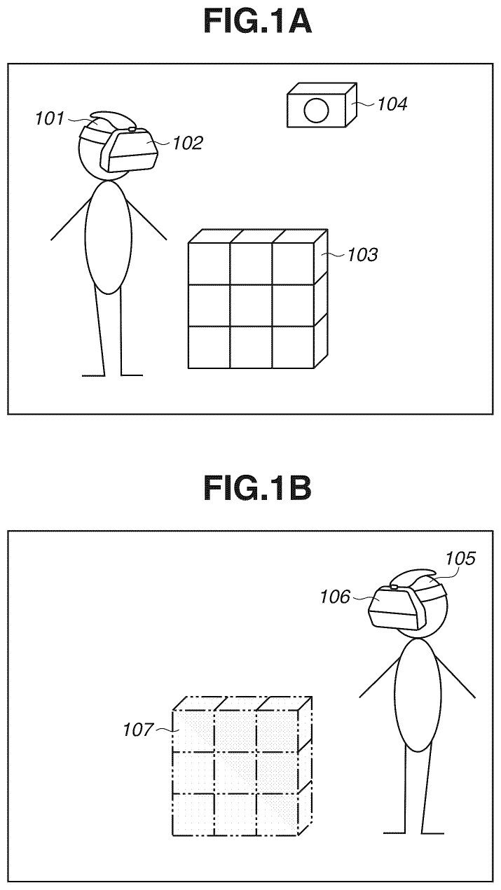

FIGS. 1A and 1B schematically illustrate positional relations of two different users. FIG. 1A illustrates a first user 101 wearing a Head Mount Display (HMD) 102 in a space where any desired real object 103 and three-dimensional device 104 are disposed. The real object 103 is an example of a real object.

FIG. 1B illustrates a second user 105 wearing an HMD 106 in a space where the real object 103 illustrated in FIG. 1A is not disposed. This space is positioned at a position separated from the first user 101. The second user 105 is an example of a user, and the first user 101 is an example of another user. The HMD 106 worn by the second user 105 is an example of a display apparatus, and the HMD 102 worn by the first user 101 is an example of another display apparatus.

In this example, the three-dimensional device 104 acquires three-dimensional information about the real object 103, generates a virtual object 107 based on the information, and shares the information in the information apparatus of the second user 105.

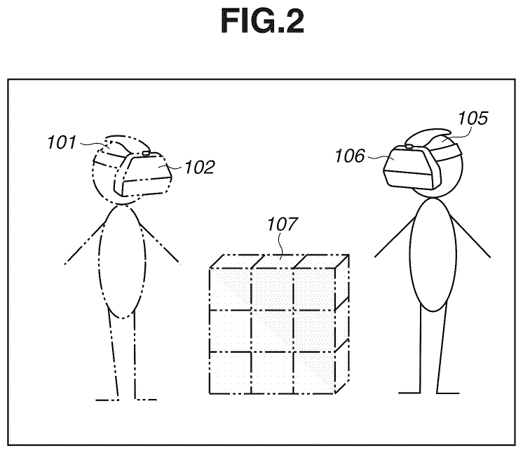

FIG. 2 is a schematic view illustrating a case where the virtual object 107 is shared with the second user 105.

The first user 101 and the second user 105 communicate with each other while the first user 101 is observing the real object 103 by using the HMD 102 attached thereto, and the second user 105 is observing the virtual object 107 by using the HMD 106 attached thereto. With the virtual object 107 shared by the two users, the shape of the real object 103 may not be exactly reproduced. In the schematic views, the real object 103 may be partly missing to represent the inexactness. In this case, a communication discrepancy may occur between the first user 101 and the second user 105 in the MR space.

Thus, a discrepancy between the view of the real object 103 observed by the first user 101 and the view of the virtual object 107 observed by the second user 105 causes a communication confusion.

The present disclosure alleviates the above-described problem by presenting the line-of-sight image of the first user 101 to the second user 105 as two-dimensional information in the virtual space of the second user 105. A specific exemplary embodiment will be described below.

The following exemplary embodiment indicates an example where the present disclosure is specifically implemented, and is one of exemplary embodiments of the configurations within the ambit of the appended claims.

A first exemplary embodiment will be described below centering on an example for obtaining gaze point regions based on the gaze points of the first user 101 and the second user 105, and determining whether to present the line-of-sight image of the first user 101 to the second user 105 depending on the overlapping of the gaze point regions of the two users.

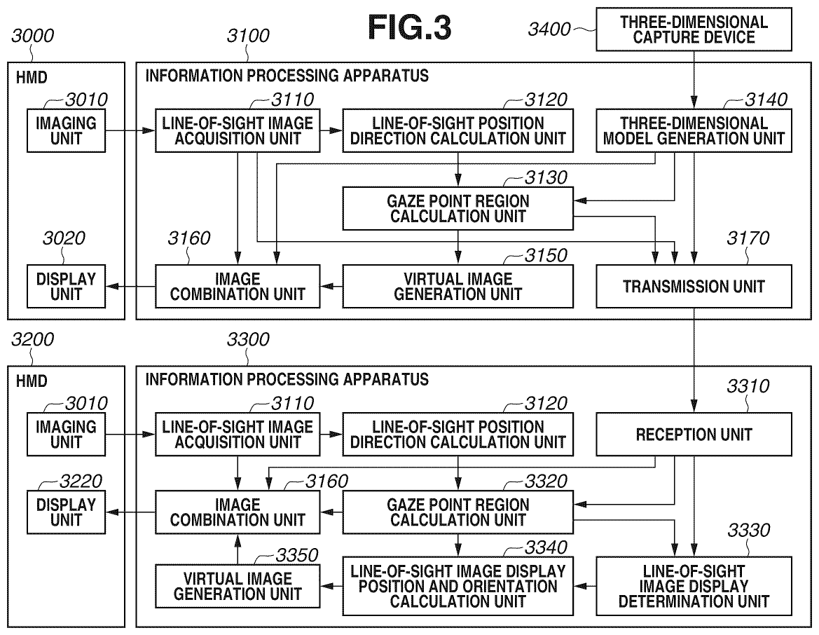

FIG. 3 is a block diagram illustrating an example configuration of the system according to the first exemplary embodiment of the present disclosure.

In the system according to the present exemplary embodiment, an information processing apparatus 3100 is connected to an HMD 3000, a three-dimensional capture device 3400, and an information processing apparatus 3300. In the system according to the present exemplary embodiment, the information processing apparatus 3300 is connected to an HMD 3200 and the information processing apparatus 3100. The following description will be made on the premise that the HMD 102 (FIG. 1A) is configured as the HMD 3000, the HMD 106 (FIG. 1B) is configured as the HMD 3200, and the three-dimensional capture device 104 (FIG. 1A) is configured as the three-dimensional capture device 3400.

Applicable connection forms include wired connection, wireless connection, and a combination of both. The information processing apparatus 3100 will be described below.

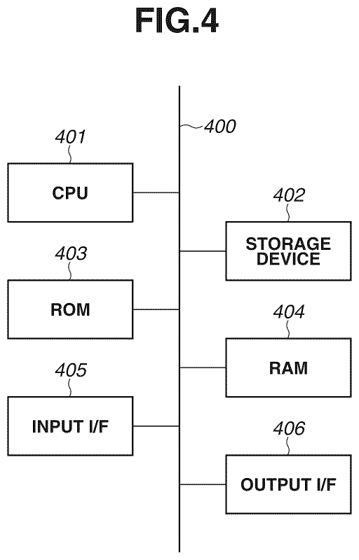

FIG. 4 illustrates a hardware configuration of the information processing apparatus 3100 according to the present exemplary embodiment. A Central Processing Unit (CPU) 401 totally controls the devices connected via a bus 400. The CPU 401 reads and executes processing steps and programs stored in a Read Only Memory (ROM) 403 and a Random Access Memory (RAM) 404.

A storage device 402 stores programs and data related to the use of the information processing apparatus 3100 including various programs according to the present exemplary embodiment.

The ROM 403 stores an operating system (OS), device drivers, and a boot program.

A Random Access Memory (RAM) 404 includes a work area for temporarily storing a program and data loaded from the storage device 402 and the ROM 403 to allow the CPU 401 to suitably execute each piece of processing.

An input interface (I/F) 405 inputs an input signal in a format processable by the information processing apparatus 3100 from an external apparatus including the HMD 3000.

An output I/F 406 outputs to an external apparatus including the HMD 3000 an output signal in a format processable by the external apparatus.

A line-of-sight image acquisition unit 3110 acquires a real-world image (line-of-sight image) captured by an imaging unit 3010 of the HMD 3000. The line-of-sight image acquisition unit 3110 inputs the acquired image to a line-of-sight position direction calculation unit 3120, an image combination unit 3160, and a transmission unit 3170.

The line-of-sight position direction calculation unit 3120 subjects the real image acquired by the line-of-sight image acquisition unit 3110 to image processing, extracts points, lines, and other characteristic information in the image, and measures the line-of-sight position and orientation of the first user 101. The line-of-sight direction of the first user 101 may be calculated from the direction the user faces by using the position of the HMD 3000 as a line-of-sight start point, or may be the direction of the ray thrown by using any desired point of the line-of-sight image as a start point. Line-of-sight position and orientation information about the first user 101 is input to a gaze point region calculation unit 3130.

A three-dimensional model generation unit 3140 generates the virtual object 107 by using the three-dimensional information about the real object 103 acquired through imaging by the three-dimensional capture device 3400, and measures the position of the virtual object 107. The three-dimensional capture device 3400 may use a plurality of cameras, a depth sensor, or a combination of cameras and the depth sensor.

The position and orientation of the virtual object 107 may be measured based on multi-viewpoint images captured by the plurality of cameras. The position and orientation may be measured by using infrared light or by using an ultrasonic sensor, magnetic sensor, or depth sensor. With an index displayed on the space, the position and orientation of the virtual object 107 may be measured by estimating the position and orientation of the index displayed on the line-of-sight image. The position and orientation of the virtual object 107 may be measured by using a Global Navigation Satellite System (GNSS) such as a Global Positioning System (GPS).

Usable data for the virtual object 107 include prestored data (shape information and position and orientation information) regarding the virtual object 107 configuring the virtual space, and prestored data regarding a light source for emitting light into the virtual space.

The virtual object 107 is input to the transmission unit 3170, and the positional information about the virtual object 107 is input to the gaze point region calculation unit 3130.

The gaze point region calculation unit 3130 calculates the gaze point region of the first user 101 based on the line-of-sight position and orientation information about the first user 101 and the positional information about the virtual object 107. Instead of the positional information about the virtual object 107, positional information about the real object 103 corresponding to the virtual object 107 is also applicable.

Examples of a gaze point region include a spherical region having a collision point (also referred to as a contact point) between the ray in the line-of-sight position and orientation direction and the virtual object 107 (the real object 103 is also applicable), and any desired radius centering on the collision point. Although the present exemplary embodiment will be described below centering on the calculation of the gaze point region based on the collision point between the line-of-sight ray of the first user 101 and the virtual object 107, the present disclosure is not limited thereto.

The gaze point region may be acquired based on the collision point between the ray thrown from any desired point of the line-of-sight image and the virtual object 107. Instead of the collision point, the gaze point region may be acquired based on a point at any desired distance in the front direction obtained from the line-of-sight position and orientation. The gaze point region of the first user 101 is input to the image combination unit 3160.

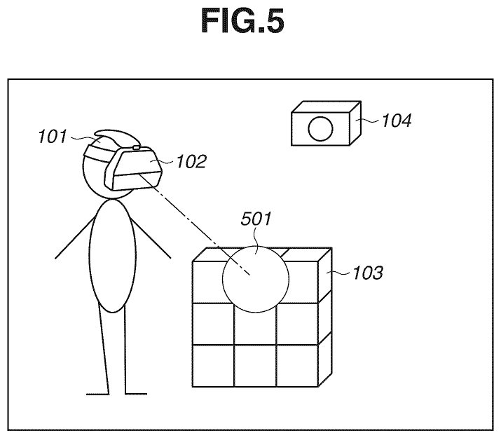

FIG. 5 schematically illustrates the line-of-sight region of the first user 101 according to the present exemplary embodiment. The first user 101 wears the HMD 102 on the head and has an MR experience in the MR space where the real object 103 exists.

A gaze point region 501 is displayed on the surface of the real object 103. The gaze point region 501 is calculated from the collision point between the ray thrown in the line-of-sight direction from the HMD 102 and the virtual object 107 simulating the real object 103 acquired by the three-dimensional capture device 104.

The transmission unit 3170 inputs the line-of-sight image of the first user 101, position and orientation information about the gaze point region 501 of the first user 101, and information about the generated virtual object 107 to a reception unit 3310 of the information processing apparatus 3300.

A virtual image generation unit 3150 generates an image (virtual image) including the calculated gaze point region 501 disposed as a schematic spherical model (visible region) on the virtual space viewable from the position and orientation calculated by the line-of-sight position direction calculation unit 3120. The generated virtual image is input to the image combination unit 3160.

The technique for generating an image in the virtual space viewable from a predetermined position is a known technique, and detailed description thereof will be omitted.

The image combination unit 3160 generates an image in a mixed reality space (mixed reality image) by superimposing the virtual image generated by the virtual image generation unit 3150 on the real image acquired by the line-of-sight image acquisition unit 3110. The generated mixed reality image is output to a display unit 3020 of the HMD 3000.

The HMD 3000 will be described below.

The HMD 3000 is a display apparatus including a liquid crystal display (LCD) screen, provided for each of the right and left eyes. The HMDs 3000 are attached so that, when the user wears the HMD on the head, the HMDs 3000 are positioned in front of the right and left eyes. Stereo images having a parallax are displayed on the right and left screens. The present exemplary embodiment will be described below on the premise that the HMD 3000 is a video see-through type HMD that displays on the display apparatus the mixed reality image generated based on images captured by an imaging apparatus. However, the present disclosure is not limited thereto. An optical see-through type HMD is also applicable, which superimposes a virtual-space image on a display medium that allows observation through the real space.

The imaging unit 3010 captures an image of the real space reflected on the HMD 3000 and inputs the captured real image to the information processing apparatus 3100.

The display unit 3020 displays the mixed reality image generated by the information processing apparatus 3100.

The information processing apparatus 3300 will be described below. Components having the same functions as those of the information processing apparatus 3100 are assigned the same reference numerals, and redundant descriptions thereof will be omitted. More specifically, the line-of-sight image acquisition unit 3110, the line-of-sight position direction calculation unit 3120, and the image combination unit 3160 are as described above, and redundant descriptions thereof will be omitted.

The reception unit 3310 is an example of an acquisition unit. The reception unit 3310 acquires, for example, the line-of-sight image of the first user 101, the position and orientation information about the gaze point region 501 of the first user 101, and the information about the generated virtual object 107 from transmission unit 3170 of information processing apparatus 3100.

The line-of-sight image of the first user 101 is input to the image combination unit 3160, the position and orientation information about the gaze point region 501 of the first user 101 is input to a line-of-sight image display determination unit 3330, and the information about the virtual object 107 is input to a gaze point region calculation unit 3320.

The gaze point region calculation unit 3320 of the information processing apparatus 3300 calculates the gaze point region of the second user 105 based on the positional information about the virtual object 107 acquired from the reception unit 3310 and the line-of-sight position direction of the second user 105 acquired from the line-of-sight position direction calculation unit 3120. The calculation method is similar to that for the information processing apparatus 3100, and redundant descriptions thereof will be omitted.

The position and orientation information about the gaze point region of the second user 105 is input to the line-of-sight image display determination unit 3330 and a line-of-sight image display position and orientation calculation unit 3340.

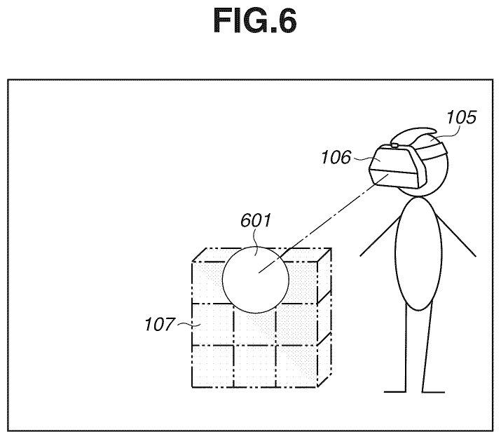

FIG. 6 schematically illustrates the line-of-sight region of the second user 105 and the MR space according to the present exemplary embodiment. The second user 105 wears the HMD 106 on the head and has an MR experience in the MR space where the virtual object 107 acquired by the reception unit 3310 exits.

A gaze point region 601 is displayed on the surface of the virtual object 107. The gaze point region 601 is calculated from the collision point between the ray thrown in the line-of-sight direction from the HMD 106 and the virtual object 107 simulating the real object 103 acquired by the three-dimensional capture device 3400.

The line-of-sight image display determination unit 3330 determines whether to present the line-of-sight image of the first user 101 to the second user 105, based on the gaze point region 501 of the first user 101 and the gaze point region 601 of the second user 105. For example, the line-of-sight image display determination unit 3330 determines to present the line-of-sight image of the first user 101 to the second user 105 when the gaze point region 501 of the first user 101 and the gaze point region 601 of the second user 105 satisfy a predetermined criterion. The line-of-sight image display determination unit 3330 determines not to present the line-of-sight image of the first user 101 to the second user 105 when the gaze point region 501 of the first user 101 and the gaze point region 601 of the second user 105 do not satisfy the predetermined criterion.

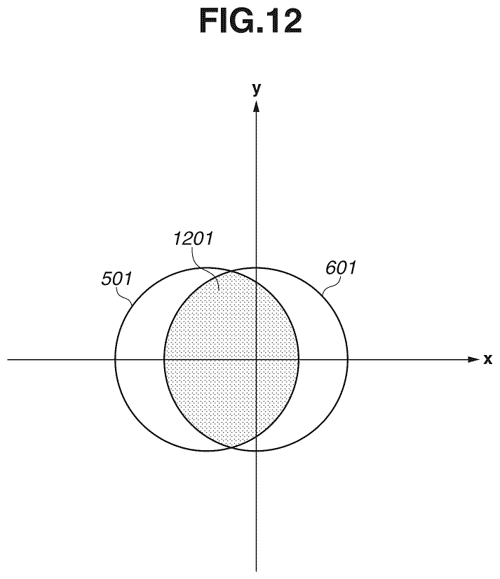

FIG. 12 illustrates a region (common region) where two spheres of the gaze point region 501 of the first user 101 and the gaze point region 601 of the second user 105 overlap on the xy plane. When viewed from the xy plane, the volume of a rotating body formed by rotating a shaded portion 1201 where the gaze point region 501 and the gaze point region 601 overlap, around the x axis is the volume of the common region between the two gaze point regions. Since a known method is used to obtain the volume of the common region between two different spheres, detailed description of the method will be omitted.

If the volume of the common region is larger than a specified threshold value, a line-of-sight image display determination flag for presenting the line-of-sight image of the first user 101 to the second user 105 is set to ON. Although the present exemplary embodiment determines that the flag is ON based on the volume of the common region between the spherical gaze point regions of the first user 101 and the second user 105, the present disclosure is not limited thereto.

The present exemplary embodiment may also perform the determination based on the collision between the gaze point region 501 of the first user 101 and the gaze point region 601 of the second user 105. The present exemplary embodiment may also calculate the positions and orientations of the planes where the virtual object 107 and the gaze point regions are in contact, and perform the determination based on the common region between the plane of the gaze point region 501 of the first user 101 and the plane of the gaze point region 601 of the second user 105.

The present exemplary embodiment may also acquire the viewpoint start position of the first user 101 and the viewpoint start position of the second user 105, and perform the determination based on the distance between the two points on the virtual space.

The present exemplary embodiment may also perform the determination according to whether the gaze point region 501 of the first user 101 is included in the imaging range of the line-of-sight image of the second user 105.

The present exemplary embodiment may also specify the virtual object 107 subjected to the line-of-sight image display or a more detailed region within the virtual object 107 in advance. Other applicable criteria for the determination include whether the gaze point region of the first user 101, the gaze point region of the second user 105, or the gaze point regions of both users gaze the virtual object 107.

Other applicable criteria for the determination also include the angle formed by the acquired ray directions of the first user 101 and the second user 105.

Other applicable criteria for the determination also include the elapsed time during which the common region between the gaze point regions is equal to or larger than a threshold value. Other applicable criteria for the determination also include whether the common region between the gaze point regions is retained for a predetermined time duration since a starting time when the common region becomes equal to or larger than the threshold value. The above-described plurality of determination criteria may be combined. Line-of-sight image display determination flag information is input to the line-of-sight image display position and orientation calculation unit 3340.

When the line-of-sight image display determination flag information is ON, the line-of-sight image display position and orientation calculation unit 3340 calculates the position and orientation of the line-of-sight image of the first user 101 to be presented to the second user 105.

The line-of-sight image display position and orientation calculation unit 3340 calculates, as the line-of-sight image display position and orientation, a plane perpendicular to the line-of-sight direction of the second user 105. In this case, the present exemplary embodiment may adjust the line-of-sight image display position to a position where the display of the virtual object 107 is not hidden, based on the position and orientation of the virtual object 107 viewable from the position of the second user 105.

The present exemplary embodiment may also acquire the depth value of the virtual object 107 and perform display at a position in front of the virtual object 107 in the line-of-sight direction of the second user 105. The present exemplary embodiment may also calculate and display, as the line-of-sight image display position and orientation, a plane perpendicular to the line-of-sight direction of the first user 101. The calculated line-of-sight image display position and orientation are input to a virtual image generation unit 3350.

When the line-of-sight image display determination flag information is ON, the virtual image generation unit 3350 of the information processing apparatus 3300, as an example of a generation unit, generates a combined image including at least the line-of-sight image of the first user 101. When the line-of-sight image display determination flag information is ON, the virtual image generation unit 3350 may generate a combined image including the line-of-sight image of the first user 101 and the virtual object 107.

The virtual image generation unit 3350 generates a virtual image including the gaze point region 601 of the second user 105 disposed as a schematic spherical model (visible region) on the virtual space viewable from the position and orientation calculated by the line-of-sight position direction calculation unit 3120.

The virtual image generation unit 3350 also generates a virtual image including the virtual object 107 disposed on the virtual space viewable from the position and orientation calculated by the line-of-sight position direction calculation unit 3120 when the virtual object 107 is disposed in a predetermined position and orientation in the MR space.

When the line-of-sight image display determination flag information is ON, the virtual image generation unit 3350 generates a virtual image including the line-of-sight image of the first user 101 disposed in the line-of-sight image display position and orientation. The generated virtual image is input to the image combination unit 3160.

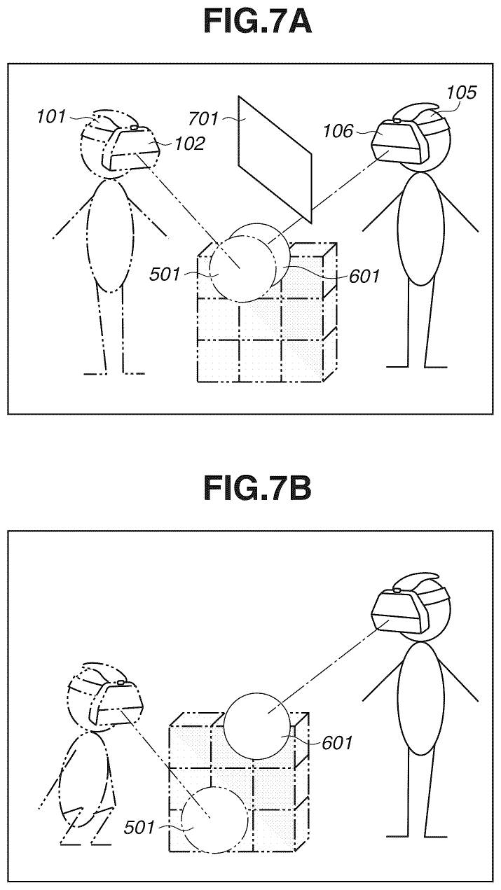

FIGS. 7A and 7B schematically illustrate the line-of-sight regions of the first user 101 and the second user 105, respectively, viewed from the MR space of the second user 105 according to the present exemplary embodiment. FIG. 7A illustrates the gaze point region when the first user 101 and the second user 105 observe the same object. In this case, the common region between the gaze point regions of the first user 101 and the second user 105 is larger than a preliminarily specified threshold value. Thus, when the line-of-sight image display determination unit 3330 sets the line-of-sight image display determination flag to ON, a line-of-sight image 701 of the first user 101 is displayed in the virtual space of the second user 105.

FIG. 7B illustrates gaze point regions when the first user 101 and the second user 105 observe different objects. In this case, there is no common region between the gaze point regions of the first user 101 and the second user 105. Therefore, the line-of-sight image display determination unit 3330 does not set the line-of-sight image display determination flag to ON, and the line-of-sight image 701 of the first user 101 is not displayed in the virtual space of the second user 105.

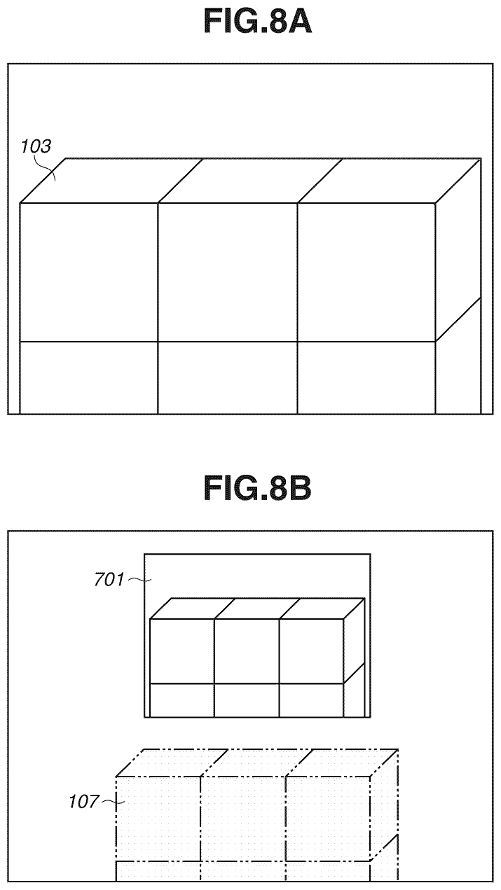

FIGS. 8A and 8B schematically illustrate the line-of-sight images of the first user 101 and the second user 105, respectively, according to the present exemplary embodiment. FIG. 8A illustrates the line-of-sight image 701 of the first user 101 viewing the real object 103 when the line-of-sight image display determination unit 3330 sets the line-of-sight image display determination flag to ON.

FIG. 8B illustrates the line-of-sight image of the second user 105 viewing the virtual object 107 when the line-of-sight image display determination unit 3330 sets the line-of-sight image display determination flag to ON. The line-of-sight image 701 of the first user 101 is combined on the line-of-sight image viewed by the second user 105, based on the line-of-sight image display position and orientation calculated by the line-of-sight image display position and orientation calculation unit 3340. In this case, if a part of the real object 103 is missing from the virtual object 107, a communication discrepancy may occur between the first user 101 and the second user 105. However, the second user 105 can observe the real object 103 by viewing the line-of-sight image 701 of the first user 101.

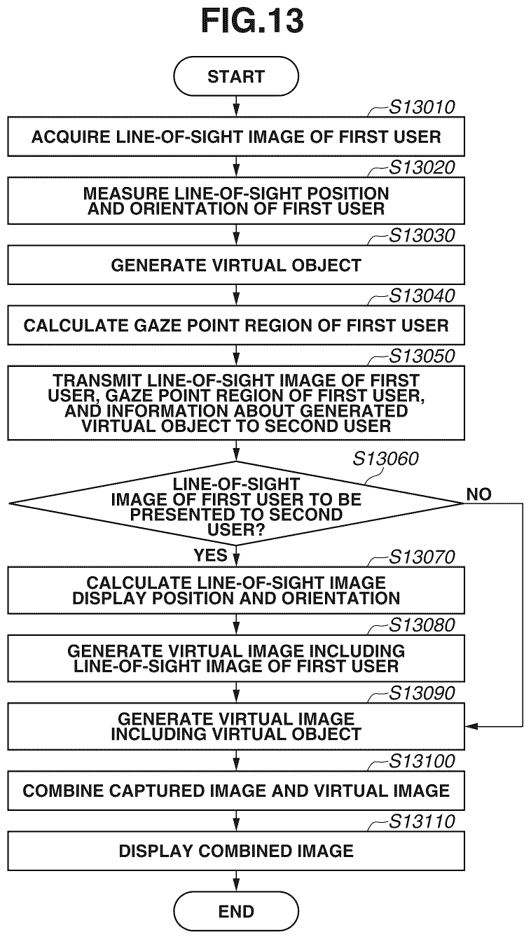

FIG. 13 is a flowchart illustrating processing for presenting the line-of-sight image 701 of the first user 101 acquired by the information processing apparatus 3100 to the second user 105 through information processing apparatus 3300. In the following descriptions, each process (step) is supplied with a leading “S”.

In step S13010, the line-of-sight image acquisition unit 3110 acquires the line-of-sight image from the imaging unit 3010. Then, the processing proceeds to step S13020.

In step S13020, the line-of-sight position direction calculation unit 3120 subjects the line-of-sight image to image processing and measures the line-of-sight position and orientation of the first user 101. Then, the processing proceeds to step S13030.

In step S13030, the three-dimensional model generation unit 3140 generates the virtual object 107 by using the three-dimensional information about the real object 103 acquired by the three-dimensional capture device 3400 and measures the position of the virtual object 107. Then, the processing proceeds to step S13040.

In step S13040, the gaze point region calculation unit 3130 calculates the gaze point region of the first user 101 based on the line-of-sight position and orientation information about the first user 101 and the positional information about the virtual object 107. Then, the processing proceeds to step S13050.

In step S13050, the transmission unit 3170 inputs the line-of-sight image of the first user 101, the gaze point region of the first user 101, and information about the generated virtual object 107 to the reception unit 3310 of the information processing apparatus 3300. Then, the processing proceeds to step S13060.

In step S13060, the line-of-sight image display determination unit 3330 determines whether to present the line-of-sight image of the first user 101 to the second user 105, based the gaze point regions of the first user 101 and the second user 105. If the line-of-sight image display determination unit 3330 determines to present the line-of-sight image of the first user 101 (YES in step S13060), the processing proceeds to step S13070. If the line-of-sight image display determination unit 3330 determines not to present the line-of-sight image of the first user 101 (NO in step S13060), the processing proceeds to step S13090.

In step S13070, the line-of-sight image display position and orientation calculation unit 3340 calculates, as the line-of-sight image display position and orientation, a plane perpendicular to the line-of-sight direction of the second user 105. Then, the processing proceeds to step S13080.

In step S13080, the virtual image generation unit 3350 generates a virtual image including the line-of-sight image of the first user 101 disposed in the line-of-sight image display position and orientation. Then, the processing proceeds to step S13090.

In step S13090, the virtual image generation unit 3350 generates a virtual image including the virtual object 107 disposed in a predetermined position and orientation in the MR space. Then, the processing proceeds to step S13100.

In step S13100, the image combination unit 3160 superimposes the virtual image generated by the virtual image generation unit 3350 on the real image to generates a mixed reality image. Then, the processing proceeds to step S13110.

In step S13110, the image combination unit 3160 outputs the generated mixed reality image to a display unit 3220 of the HMD 3200.

The processing in step S13060 for determining whether to present the line-of-sight image of the first user 101 to the second user 105 will be described below.

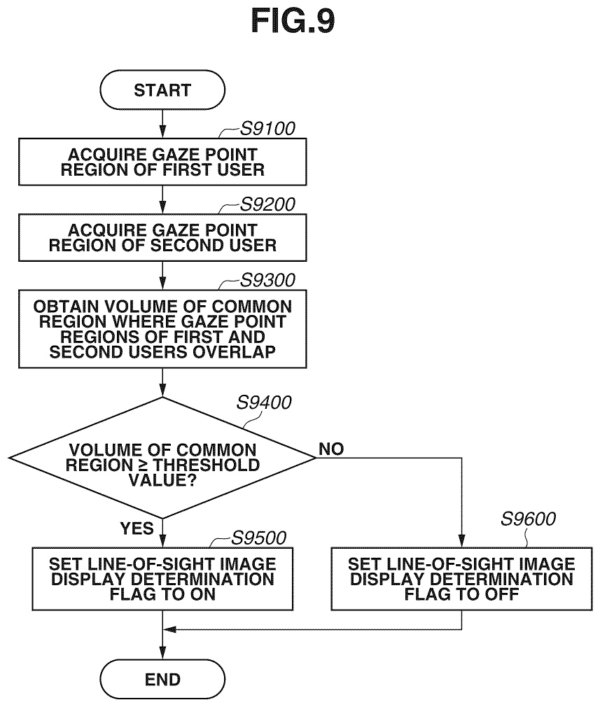

FIG. 9 is an example of a flowchart illustrating processing performed by the line-of-sight image display determination unit 3330 to determine whether to present the line-of-sight image 701 of the first user 101 to the second user 105.

In step S9100, the line-of-sight image display determination unit 3330 acquires the gaze point region of the first user 101 from the reception unit 3310. Then, the processing proceeds to step S9200.

In step S9200, the line-of-sight image display determination unit 3330 acquires the gaze point region of the second user 105 from the gaze point region calculation unit 3320. Then, the processing proceeds to step S9300.

In step S9300, the line-of-sight image display determination unit 3330 calculates the volume of the common region where the two spheres of the gaze point regions of the first user 101 and the second user 105 overlap. Then, the processing proceeds to step S9400.

If the volume of the common region is larger than or equal to a preliminarily specified threshold value (YES in step S9400), the processing proceeds to step S9500. If the volume of the common region is smaller than the preliminarily specified threshold value (NO in step S9400), the processing proceeds to step S9600.

In step S9500, the line-of-sight image display determination unit 3330 sets the line-of-sight image display determination flag to ON to present the line-of-sight image of the first user 101 to the second user 105. Then, the line-of-sight image display determination unit 3330 terminates the processing and then transfers control to the line-of-sight image display position and orientation calculation unit 3340.

In step S9600, the line-of-sight image display determination unit 3330 sets the line-of-sight image display determination flag to OFF. The line-of-sight image display determination unit 3330 terminates the processing and then transfers control to the line-of-sight image display position and orientation calculation unit 3340.

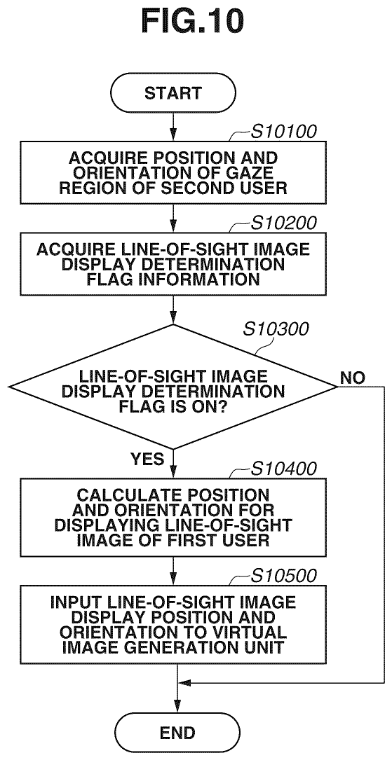

FIG. 10 is an example of a flowchart illustrating processing performed by the line-of-sight image display position and orientation calculation unit 3340 to calculate the position and orientation of line-of-sight image 701 of the first user 101 to be presented to the second user 105.

In step S10100, the line-of-sight image display position and orientation calculation unit 3340 acquires the line-of-sight start point and the line-of-sight direction of the second user 105 from the gaze point region calculation unit 3320. Then, the processing proceeds to step S10200.

In step S10200, the line-of-sight image display position and orientation calculation unit 3340 acquires the line-of-sight image display determination flag information from the line-of-sight image display determination unit 3330. Then, the processing proceeds to step S10300.

In step S10300, the line-of-sight image display position and orientation calculation unit 3340 determines whether the line-of-sight image display determination flag information is ON. If the line-of-sight image display determination flag information is ON (YES in step S10300), the processing proceeds to step S10400. If the line-of-sight image display determination flag information is OFF (NO in step S10300), the line-of-sight image display position and orientation calculation unit 3340 terminates the processing and then transfers control to the virtual image generation unit 3350.

In step S10400, the line-of-sight image display position and orientation calculation unit 3340 calculates, as the line-of-sight image display position and orientation, a plane perpendicular to the line-of-sight direction of the second user 105. In this case, the present exemplary embodiment may adjust the line-of-sight image display position to a position where the display of the virtual object 107 is not hidden, based on position and orientation of the virtual object 107 viewable from the position of the second user 105.

In other words, a position where the display of the virtual object 107 is not hidden is also referred to as a position that does not overlap with the display position of the virtual object 107. Then, the processing proceeds to step S10500.

In step S10500, the line-of-sight image display position and orientation calculation unit 3340 inputs the calculated line-of-sight image display position and orientation to the virtual image generation unit 3350. The line-of-sight image display position and orientation calculation unit 3340 terminates the processing and then transfers control to the virtual image generation unit 3350.

Thus, the line-of-sight image 701 of the first user 101 can be included in the combined image displayed on the display unit 3220 of the second user 105.

According to the present exemplary embodiment, the viewpoint image of the user including the real object 103 can be displayed as a two-dimensional image in the virtual space of the user not including the real object 103. This enables preferable communication in an MR experience.

### First Modification

Although the first exemplary embodiment has been described above centering on an example where the line-of-sight image display determination unit 3330 determines whether to present the line-of-sight image 701, based on the gaze point region calculated from the line-of-sight positions and orientations of the first user 101 and the second user 105, the present disclosure is not limited thereto. The user may be able to determine whether to present the line-of-sight image.

More specifically, the line-of-sight image display determination flag may be operated based on an operation input from the user.

This processing can be implemented by changing the line-of-sight image display determination flag through an operation input from the user. A user operation may be input through at least one of input methods including button input (with a button-type apparatus such as a controller device or keyboard), gesture input, and voice input.

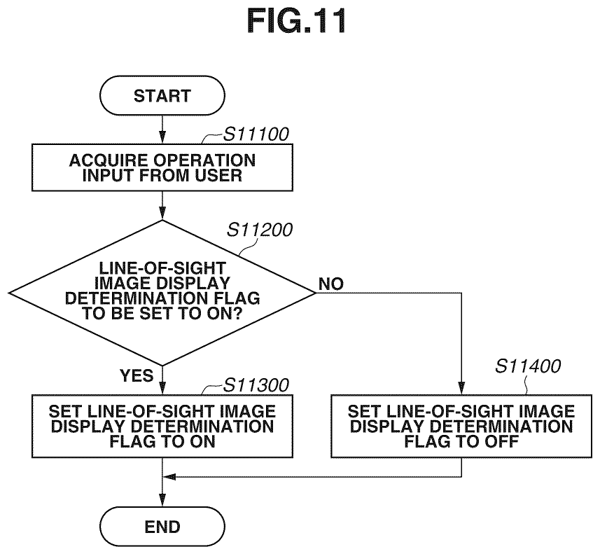

FIG. 11 is an example of a flowchart illustrating control of processing performed by the line-of-sight image display determination unit 3330 to determine whether to present the line-of-sight image 701 of the first user 101 to the second user 105, based on an operation input from the user.

If the operation input of the second user 105 acquired in step S11100 is an operation for setting the line-of-sight image display determination flag to ON (YES in step S11200), the processing proceeds to step S11300. If the operation input of the second user 105 is an operation for setting the line-of-sight image display determination flag to OFF (NO in step S11200), the processing proceeds to step S11400.

In step S11300, the line-of-sight image display determination unit 3330 sets the line-of-sight image display determination flag to ON to present the line-of-sight image of the first user 101 to the second user 105. The line-of-sight image display determination unit 3330 terminates the processing and then transfers control to the line-of-sight image display position and orientation calculation unit 3340.

In step S11400, the line-of-sight image display determination unit 3330 sets the line-of-sight image display determination flag to OFF not to present the line-of-sight image of the first user 101 to the second user 105.

The line-of-sight image display determination unit 3330 terminates the processing and then transfers control to the line-of-sight image display position and orientation calculation unit 3340. The subsequent processing is similar to that according to the first exemplary embodiment, and redundant descriptions thereof will be omitted.

This enables determining whether the line-of-sight image 701 of the first user 101 is to be included in the combined image displayed on the display unit 3220 of the second user 105, according to an operation input from the user.

### Second Modification

According to the first exemplary embodiment, the image capacity and size may be set for the line-of-sight image 701 of the first user 101 to be transmitted to the second user 105.

More specifically, the amount of data of the line-of-sight image 701 of the first user 101 may be made variable through an operation input from the user. This processing can be implemented by changing the line-of-sight image display determination flag through an operation input from the user. A user operation may be input through at least one of input methods including button input (with a button-type apparatus such as a controller device or keyboard), gesture input, and voice input.

The line-of-sight image 701 may be trimmed through an operation input from the user. This processing can be implemented by enabling a trimming area in the line-of-sight image to be set through an operation input from the user. In addition, the first exemplary embodiment may control the line-of-sight image based on a network band. For a narrow network band, for example, the first exemplary embodiment may intentionally degrade the image quality of the line-of-sight image 701 and reduce the image.

A user operation may be input through at least one of input methods including button input (with a button-type apparatus such as a controller device or keyboard), gesture input, and voice input.

While the present disclosure has specifically been described based on the above-described preferred exemplary embodiments, the present disclosure is not limited thereto, naturally, but can be modified and changed in diverse ways within the scope of the appended claims.

### OTHER EXEMPLARY EMBODIMENTS

The present disclosure is implemented also by performing the following processing. More specifically, software (program) for implementing the functions of the above-described exemplary embodiments is supplied to a system or apparatus via a network or various types of storage media, and a computer (or a control unit or micro processing unit (MPU)) of the system or apparatus reads and executes the program code. In this case, the program and the storage medium storing the program are included in the present disclosure.

While the present disclosure has specifically been described in detail above based on exemplary embodiments, the present disclosure is not limited to these specific exemplary embodiments. Diverse embodiments not departing from the spirit and scope of the present disclosure are also included in the present disclosure. Parts of the above-described exemplary embodiments may be suitably combined.

Each function unit according to the above-described exemplary embodiments (modifications) may or may not be an individual hardware component. Functions of a plurality of function units may be implemented by a common hardware component. Each of a plurality of functions of one function unit may be implemented by an individual hardware component. Two or more functions of one function unit may be implemented by a common hardware component. Each function unit may or may not be implemented by an Application Specific Integrated Circuit (ASIC), Field Programmable Gate Array (FPGA), Digital Signal Processor (DSP), and other hardware components. For example, the apparatus may include a processor and a memory (storage medium) storing control programs. Functions of at least some of function units included in the apparatus may be implemented when the processor reads a control program from the memory and executes the control program.

The present disclosure can also be achieved when a program for implementing at least one of the functions according to the above-described exemplary embodiments is supplied to a system or apparatus via a network or storage medium, and at least one processor in the computer of the system or apparatus reads and executes the program. Further, the present disclosure can also be achieved by a circuit, such as an application specific integrated circuit (ASIC), for implementing at least one function.

### Configuration 1

An information processing apparatus for controlling display of a display apparatus worn by a user includes an acquisition unit configured to acquire a line-of-sight image of another user wearing another display apparatus and information about a virtual object corresponding to a real object disposed in a space where the other user exists, and a generation unit configured to generate a combined image including at least the line-of-sight image of the other user when a line-of-sight of the user to the virtual object displayed on the display apparatus and a line-of-sight of the other user to the real object satisfy a predetermined criterion.

### Configuration 2

There is provided the information processing apparatus according to configuration 1, wherein the generation unit generates a combined image including at least the virtual object and the line-of-sight image of the other user when the line-of-sight of the user to the virtual object displayed on the display apparatus and the line-of-sight of the other user to the real object satisfy a predetermined criterion.

### Configuration 3

There is provided the information processing apparatus according to configuration 2, wherein the generation unit generates a combined image including at least the virtual object and the line-of-sight image of the other user when a gaze point region of the user to the virtual object and a gaze point region of the other user to the real object satisfy a predetermined criterion.

### Configuration 4

There is provided the information processing apparatus according to any one of configurations 1 to 3, wherein a gaze point region of the user is a region based on a contact point between the line-of-sight of the user and the virtual object, and wherein a gaze point region of the other user is a region based on a contact point between the line-of-sight of the other user and the virtual object.

### Configuration 5

There is provided the information processing apparatus according to configuration 4, wherein the gaze point region of the user is a spherical region centering on the contact point between the line-of-sight of the user and the virtual object, and wherein the gaze point region of the other user is a spherical region centering on the contact point between the line-of-sight of the other user and the virtual object.

### Configuration 6

There is provided the information processing apparatus according to configuration 5, wherein the generation unit generates a combined image including at least the virtual object and the line-of-sight image of the other user when a volume of the common region between the gaze point region of the user and the gaze point region of the other user is equal to or larger than a threshold value.

### Configuration 7

There is provided the information processing apparatus according to any one of configurations 4 to 6, wherein the gaze point region of the user is a region based on line-of-sight position and orientation information about the user and positional information about the real object or the virtual object, and wherein the gaze point region of the other user is a region based on line-of-sight position and orientation information about the other user and positional information about the virtual object.

### Configuration 8

There is provided the information processing apparatus according to any one of configurations 1 to 7, further comprising a transmission unit configured to transmit the combined image generated by the generation unit to the display apparatus.

### Configuration 9

There is provided the information processing apparatus according to any one of configurations 1 to 8, wherein the virtual object is generated based on three-dimensional information acquired when a camera disposed in the space where the other user exists captures an image of the real object.

### Configuration 10

There is provided the information processing apparatus according to any one of configurations 1 to 9, wherein the line-of-sight image of the other user included in the combined image is disposed at a position not overlapping with a display position of the virtual object.

### [Method]

A computer-executable information processing method for controlling display of a display apparatus worn by a user includes acquiring a line-of-sight image of another user wearing another display apparatus and information about a virtual object corresponding to a real object disposed in a space where the other user exists, and generating a combined image including at least the line-of-sight image of the other user when a line-of-sight of the user to the virtual object displayed on the display apparatus and a line-of-sight of the other user to the real object satisfy a predetermined criterion.

### [Program]

A program for causing a computer to function as an information processing apparatus for controlling display of a display apparatus worn by a user. The information processing apparatus includes an acquisition unit configured to acquire a line-of-sight image of another user wearing another display apparatus and information about a virtual object corresponding to a real object disposed in a space where the other user exists, and a generation unit configured to generate a combined image including at least the line-of-sight image of the other user when a line-of-sight of the user to the virtual object displayed on the display apparatus and a line-of-sight of the other user to the real object satisfy a predetermined criterion.

The present disclosure makes it possible to provide a preferable MR experience of a first user and a second user by using a two-dimensional viewpoint image of the first user including a real object in an MR experience.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-010767, filed Jan. 29, 2024, which is hereby incorporated by reference herein in its entirety.

What is claimed is:

1. An information processing apparatus for controlling display of a display apparatus worn by a user, the information processing apparatus comprising:
an acquisition unit configured to acquire a line-of-sight image of another user wearing another display apparatus and information about a virtual object corresponding to a real object disposed in a space where the other user exists; and
a generation unit configured to generate a combined image including at least the line-of-sight image of the other user when a line-of-sight of the user to the virtual object displayed on the display apparatus and a line-of-sight of the other user to the real object satisfy a predetermined criterion.

2. The information processing apparatus according to claim 1, wherein the generation unit generates a combined image including at least the virtual object and the line-of-sight image of the other user when the line-of-sight of the user to the virtual object displayed on the display apparatus and the line-of-sight of the other user to the real object satisfy a predetermined criterion.

3. The information processing apparatus according to claim 2, wherein the generation unit generates a combined image including at least the virtual object and the line-of-sight image of the other user when a gaze point region of the user to the virtual object and a gaze point region of the other user to the real object satisfy a predetermined criterion.

4. The information processing apparatus according to claim 1,
wherein a gaze point region of the user is a region based on a contact point between the line-of-sight of the user and the virtual object, and
wherein a gaze point region of the other user is a region based on a contact point between the line-of-sight of the other user and the virtual object.

5. The information processing apparatus according to claim 4,
wherein the gaze point region of the user is a spherical region centering on the contact point between the line-of-sight of the user and the virtual object, and
wherein the gaze point region of the other user is a spherical region centering on the contact point between the line-of-sight of the other user and the virtual object.

6. The information processing apparatus according to claim 5, wherein the generation unit generates a combined image including at least the virtual object and the line-of-sight image of the other user when a volume of the common region between the gaze point region of the user and the gaze point region of the other user is equal to or larger than a threshold value.

7. The information processing apparatus according to claim 4,
wherein the gaze point region of the user is a region based on line-of-sight position and orientation information about the user and positional information about the real object or the virtual object, and
wherein the gaze point region of the other user is a region based on line-of-sight position and orientation information about the other user and positional information about the virtual object.

8. The information processing apparatus according to claim 1, further comprising a transmission unit configured to transmit the combined image generated by the generation unit to the display apparatus.

9. The information processing apparatus according to claim 1, wherein the virtual object is generated based on three-dimensional information acquired when a camera disposed in the space where the other user exists captures an image of the real object.

10. The information processing apparatus according to claim 1, wherein the line-of-sight image of the other user included in the combined image is disposed at a position not overlapping with a display position of the virtual object.

11. A computer-executable information processing method for controlling display of a display apparatus worn by a user, the method comprising:
acquiring a line-of-sight image of another user wearing another display apparatus and information about a virtual object corresponding to a real object disposed in a space where the other user exists; and
generating a combined image including at least the line-of-sight image of the other user when a line-of-sight of the user to the virtual object displayed on the display apparatus and a line-of-sight of the other user to the real object satisfy a predetermined criterion.

12. A non-transitory computer-readable storage medium storing a program for causing a computer to execute an information processing method for controlling display of a display apparatus worn by a user, the method comprising:
acquiring a line-of-sight image of another user wearing another display apparatus and information about a virtual object corresponding to a real object disposed in a space where the other user exists; and
generating a combined image including at least the line-of-sight image of the other user when a line-of-sight of the user to the virtual object displayed on the display apparatus and a line-of-sight of the other user to the real object satisfy a predetermined criterion.
